(19) United States
(12) Patent Application Publication
(10) Pub. No.: US 2024/0410770 A1
(43) Pub. Date: Dec. 12, 2024

(54) MULTI-LAYER ARTIFICIAL ROBOTIC SKINS WITH TACTILE, STRETCH AND TEMPERATURE SENSING CAPABILITIES

(71) Applicant: Xiaotian Steve Yao, Las Vegas, NV (US)

(72) Inventor: Xiaotian Steve Yao, Las Vegas, NV (US)

(21) Appl. No.: 18/741,685

(22) Filed: Jun. 12, 2024

Related U.S. Application Data
(60) Provisional application No. 63/507,524, filed on Jun. 12, 2023.

(51) Int. Cl. G01L 1/24; B25J 13/08

(52) U.S. Cl. CPC G01L 1/242; B25J 13/085

(57) ABSTRACT

The technology disclosed in this patent document can be implemented to provide a smart skin-like multi-layer sensing structure to include an optical fiber to provide spatially distributed optical sensing of a contact with the structure or the temperature based on changes in the optical fiber in response to the contact or temperature for various applications including robotics and others.

### PATENT PRIORITY CLAIM AND RELATED PATENT APPLICATION

This patent document claims the priority and benefits of U.S. Provisional Application No. 63/507,524 entitled “MULTI-LAYER ARTIFICIAL ROBOTIC SKINS WITH TACTILE, STRETCH AND TEMPERATURE SENSING CAPABILITIES” and filed on Jun. 12, 2023, which is incorporated by reference as part of the disclosure of this patent document.

### TECHNICAL FIELD

This patent document discloses designs of sensing devices, including multi-layer structures with optical fiber sensing as artificial robotic skins for various applications.

### BRIEF DESCRIPTION OF DRAWINGS

FIGS. 1 through 13 illustrate various examples and implementations of the disclosed multi-layer structures with optical fiber sensing as artificial robotic skins:

FIG. 1 shows an example of the multi-layer structure of a smart skin for human-like robots of the disclosed technology. The skin in this example includes three layers. The base layer is for laying the optical fiber, the middle layer is an elastic or deformable layer with an array of holes to allow force/pressure pillars to go through for transmitting the force/pressure to the fiber, and the top layer is a protective layer to cover the elastic layer and the pillars down below. The force transmitting pillars are made with relatively hard materials, such as plastic or even metal, which is placed on top of the fiber. When a force or pressure is applied on the top layer at a particular location, the pillar at that location will be pushed downward and transmit the force to the fiber beneath it, which will induce a birefringence in the fiber at that particular location via the photo-elastic effect. The amount of birefringence is directly proportional to the force applied. A distributed birefringence sensor system can be used to periodically measure the birefringence distribution and convert the birefringence readings into force readings.

FIG. 2 includes FIG. 2a and FIG. 2b. FIG. 2a shows the top view of the base layer on which the fiber is laid in a zig-zag pattern, with the spacing between the fibers defining the vertical resolution. Micro trenches with a depth less than the fiber radius can be pre-made on the base layer for guiding the fiber. The bottom of the trench should be plat for the maximum birefringence induction sensitivity for a giver transverse force. The fiber can be laid automatically with a fiber routing machine. Adhesive can be used to glue the fiber on the base plate with or without trench. FIG. 2b shows the side view of the base layer, which preferably has a thickness between 0.1 to 1 mm.

FIG. 3 includes FIG. 3a and FIG. 3b. FIG. 3a shows the top view of the middle elastic layer with an array of holes for guiding the force transmitting pillars to go through. This layer is directly put on top of the base layer and each line of the holes is directly on top of the optical fiber, with the optical fiber running cross the center of the holes. An adhesive may be used to glue this layer to the base layer. FIG. 3b shows the side view of the elastic layer, which preferably has a thickness between 0.2 to 1 mm.

FIG. 4 includes FIG. 4a and FIG. 4b. FIG. 4a shows the top view of the top layer with an array of pillars for transmitting the force/pressure to the fiber laid on the base layer through the holes in the middle layer. The pillars can be directly molded on the top sheet or can be made separately with or without attaching to the top sheet. FIG. 4b shows the side view of the top layer with the force-transmitting pillars. The thickness of the top sheet is preferably between 0.1 to 1 mm and the height of the thickness is between 0.2 mm to 1 mm.

FIG. 5 includes FIG. 5a and FIG. 5b. FIG. 5a shows a circular spiral fiber routing pattern while FIG. 5b shows a rectangular spiral pattern.

FIG. 6 shows an example of a different design of a force transmitting pillar where this design is to minimize the friction between the pillars and the holes in the middle elastic layer. In this example, a piston like structure is disclosed to include a shell and a rod as an example. The shells are inserted in the holes of the middle layer and the rods are inserted in their corresponding shells. In some implementations, both the shell and the rod can be made with or coated with a self-lubricating material, such as molybdenum disulfide (MoS2), graphite, polytetrafluoethylene (PTFE), linear polyethylenes (PE), and hexagonal boron nitride (h-BN) et al, for minimizing the friction and the most repeatable force transmission.

FIG. 7 includes FIG. 7a and FIG. 7b. FIG. 7a shows how a smart skin works. The input fiber is connected to a distributed transverse sensing system to send in probe light into the system for distributed optical sensing and an optional output fiber is connected to guide the output light from the fiber to the optical detection module. The output fiber is not required if the sensor system is a single-ended device, such as a polarization-analyzing frequency domain reflectometery (PA-OFDR) based device. If the sensor system is a transmissive device, such as a distributed polarization crosstalk analyzer (DPXA), then the output fiber is connected to the system. FIG. 7b shows an example of the software for operating the sensor system where a lookup table can be created to link the fiber location corresponding to a force transmitting rod, and then to the location on the XY plane of the skin, and finally map the position of the forces applied onto the skin, with their magnitude displayed on a computer screen.

FIG. 8 shows an example of a distributed polarization analysis (DPA) system, PA-OFDR. TL: tunable laser; C1, C2, C3, C4, C5: couplers; PSG: polarization state generator (see Insert for details); PSA: polarization state analyzer; PMF: polarization maintaining fiber; SMF: single mode fiber; CIR1, CIR2: circulator; BPD1, BPD2: balanced photodetectors; FRM: Faraday rotation mirror; SMF-UT: SMF under test.

FIG. 9 shows an example of the data acquisition and processing flow chart for obtaining the state of polarization (SOP) matrix as a function of z. Note Ms(z) can be reduces to a 3×3 matrix if polarization dependent loss (PDL) in the fiber can be neglected.

FIG. 10 shows examples of measurements where FIG. 10(a) shows an example of measured birefringence curve along the SMF-UT with 10 different TF's applied onto 10 different fiber segments using the same length of glass-slides (12 cm) obtained with 10 repeated measurements and FIG. 10 (b) shows an example of TF-induced birefringence as a function of TLF f. The error-bars are plotted in pink to show the measurement repeatability of our PA-OFDR system.

FIG. 11 includes FIG. 11(a) and FIG. 11(b). FIG. 11(a) shows an example of a ghost-peak-free distributed polarization crosstalk analyzer using a scanning white light Michelson interferometer. The inset shows the delay relation between the original and crosstalk components. Light with a short coherence length travelling in the fiber is polarized along its slow axis at input point A. Crosstalk is induced by a stress at point B where a small portion of light is coupled into fiber's fast axis. A relative delay at the output point C between the two polarization components is AZ. The location Z of crosstalk point B can be obtained from a measurement of AZ. FRM, MDL, PD, and DAQ are Faraday rotation mirror, Motorized Delay Line, photodetector, and data acquisition card, respectively. FIG. 11(b) show a photo of an example of a commercial ghost-peak free DPXA product developed by the inventor. With such an instrument, a spatial resolution of 6 cm, a measurement range up to 3.4 km, a crosstalk measurement sensitivity down to −80 dB, and a crosstalk dynamic range of 75 dB can be routinely achieved.

FIG. 12 shows an example of a typical polarization crosstalk curve measured with a distributed polarization crosstalk analyzer.

FIG. 13 includes FIGS. 13(a), 13(b) and 13(c) and shows an example a smart skin device in which the top layer has arrays of square shaped pillars for transmitting the force/pressure to the fiber laid on the base layer.

### SUMMARY

The disclosed technology can be implemented to construct a multi-layer device capable of sensing to include, in one embodiment, a layer that includes force sensing elements spatially distributed relative to one another, each force sensing element structured to transmit a force exerted on a first end of the sensing element on a first side of the layer to a second end of the forcing sensing element on a second side of the layer opposite to the first side; and an optical fiber located on the second side of the layer and coupled to the force sensing elements at different locations along a length of the optical fiber. The optical fiber includes a first terminal that receives input light and a second terminal, and is coupled to the second end of each force sensing element to receive a force transmitted from the force sensing element to exhibit a localized birefringence in the optical fiber induced by the transmitted force at a location of the optical fiber coupled to the force sensing element to indicate the transmitted force so that different locations of the optical fiber coupled to the different force sensing elements of the layer generate a spatially distributed sensing of forces experienced by the different force sensing elements.

In another embodiment, a multi-layer device capable of sensing can include a layer that includes force sensing elements spatially distributed relative to one another, each force sensing element structured to transmit a force exerted on a first end of the sensing element on a first side of the layer to a second end of the forcing sensing element on a second side of the layer opposite to the first side; a front sensing layer coupled to the first side of the layer to receive one or more forces to be transmitted by the force sensing elements to the second side of the layer; and an optical fiber located on the second side of the layer and coupled to the force sensing elements at different locations along a length of the optical fiber. The optical fiber includes a first terminal that receives input light and a second terminal, and is coupled to the second end of each force sensing element to receive a force transmitted from the force sensing element to exhibit a localized birefringence in the optical fiber induced by the transmitted force at a location of the optical fiber coupled to the force sensing element to indicate the transmitted force so that different locations of the optical fiber coupled to the different force sensing elements of the layer generate a spatially distributed sensing of forces experienced by the different force sensing elements.

In one implementation of the above devices, an optical detection module is included and is coupled to the first terminal of the optical fiber to launch light into the optical fiber and receive backscattered light from the optical fiber for measuring the light that carries information of the localized birefringence in the fiber induced by transmitted forces by the different force sensing elements. In some implementations, the optical detection module may include an optical frequency domain reflectometer (OFDR) with polarization analysis capability for obtaining distance resolved birefringence along the optical fiber with high spatial resolution, or the optical a time domain reflectometer (OTDR) with polarization analysis capability for obtaining distance resolved birefringence along the optical fiber with high spatial resolution. In addition, the optical detection module can be designed to include a pulsed light source to generate light pulses to the optical fiber so that the returned light pulses from the optical fiber can be detected and processed to measure a spatial distribution of the force or temperature in the optical fiber based on Brillouin time domain reflectometry (BOTDR) measurements.

In one implementation of the above devices, an optical detection module may be provided to include (1) a first optical port coupled to the first terminal of the optical fiber to send light into the optical fiber and (2) a second optical port coupled to the second terminal of the fiber to receive light from the optical fiber and to include an optical interferometer to process the received light from the optical fiber to produce an interferometer optical output having polarization crosstalk peaks with their amplitude indicative of the forces exerted on the optical fiber. The optical detection module may be configured to measure both the amplitudes and spacings of the polarization crosstalk peaks to determine temperature distribution along the optical fiber. In some applications, the optical detection module may include a distributed polarization crosstalk analyzer (DPXA) that processes the received light from the optical fiber to measure distance resolved polarization crosstalk peaks along the optical fiber, with their amplitudes indicative of the force and the spacings indicative of the local temperature.

In yet another implementation, an optical detection module may be provided and coupled to the first terminal of the optical fiber to launch light into the optical fiber and receive light from the optical fiber and to measure the light that carries information of the localized birefringence in the optical fiber induced by transmitted forces by the different force sensing elements, wherein the optical detection module is further configured to process the received light from the optical fiber to measure a spatial temperature and strain distributions along the length of the optical fiber.

In another aspect, the disclosed technology can be implemented to construct a multi-layer device capable of operating as a robotic sensing system. This device includes a deformable layer that includes a deformable material structured to include through holes spatially separated from one other, and force sensing elements disposed in the through holes, each force sensing element structured to transmit a force exerted on a first end of the sensing element on a first side of the layer to a second end of the forcing sensing element on a second side of the layer opposite to the first side; a front sensing layer coupled to the first side of the deformable layer to deform with the deformable layer and to receive one or more forces to be transmitted by the force sensing elements to the second side of the deformable layer; and an optical fiber located on the second side of the deformable layer and coupled to the force sensing elements at different locations along a length of the optical fiber. The optical fiber includes a first terminal that receives input light and a second terminal, and is coupled to the second end of each force sensing element to receive a force transmitted from the force sensing element to exhibit a localized birefringence in the optical fiber induced by the transmitted force at a location of the optical fiber coupled to the force sensing element to indicate the transmitted force so that different locations of the optical fiber coupled to the different force sensing elements of the layer generate a spatially distributed sensing of forces experienced by the different force sensing elements. This device further includes an optical detection module coupled to the optical fiber to receive light from the optical fiber to measure the received light to obtain information on a spatial force distribution or a spatial temperature distribution on the front sensing layer.

In one implementation, the optical detection module includes a first optical port coupled to a first terminal of the optical fiber to send light into the optical fiber and a second optical port coupled to a second terminal of the fiber to receive light from the optical fiber for measuring the received light to obtain information on the spatial force distribution or the spatial temperature distribution on the front sensing layer. In another implementation, the optical detection module includes an optical port coupled to one terminal of the optical fiber to send light into the optical fiber and to receive light from the optical fiber for measuring the received light to obtain information on the spatial force distribution or the spatial temperature distribution on the front sensing layer.

The above features and their implementations associated with the disclosed embodiments and other embodiments are disclosed in greater detail in the drawings, the description and the claims.

### DETAILED DESCRIPTION

Many animals generally have five sensing organs, with the eyes for seeing, the ears for hearing, the nose for smelling, the tongue for tasting, and the skin for feeling the physical stimulus and temperature variations. Among the five sensing organs, the first four are discrete sensors while the skin is a spatially distributed sensor over the animal's body that is capable of identifying or sensing the locations of stimulus on the skin, providing the sensed magnitudes of the stimulus at the locations of the stimulus, such as touching, pinching, punching, heating or cooling, among various sensing functions.

For robotic systems, discrete sensing capabilities for the functions of the eyes, cars, nose and tongue may be relatively easy to equip in robots using various sensor devices. For example, in most human-like robots today, video cameras are commonly used to capture images as the eyes to see and the microphones are used to receive audio as the cars to hear. Although not commonly deployed, the smelling and tasting capabilities may be implemented with some kind of chemical sensors capable of analyzing the contents of chemicals in the air for smelling or the substances in the form of solid or liquid as the function for tasting. However, the skin, the only distributed sensing system on the body of an animal, is much more complicated to make and implement, because an animal skin generally has millions of nerves distributed on the skin and connected to the brain via spinal nerves to sense stimulus and identify their locations. One potential way of emulating the sensing of the animal skin is to populate a large number of piezoelectric pressure sensors on a sheet structure. Powering such piezoelectric pressure sensors and transmitting their signals to a CPU for processing can face significant technical or engineering challenges in various practical applications.

The technology disclosed in this patent document can be implemented to provide a smart skin-like multi-layer structure to include an optical fiber to provide spatially distributed optical sensing of a contact with the structure or temperature.

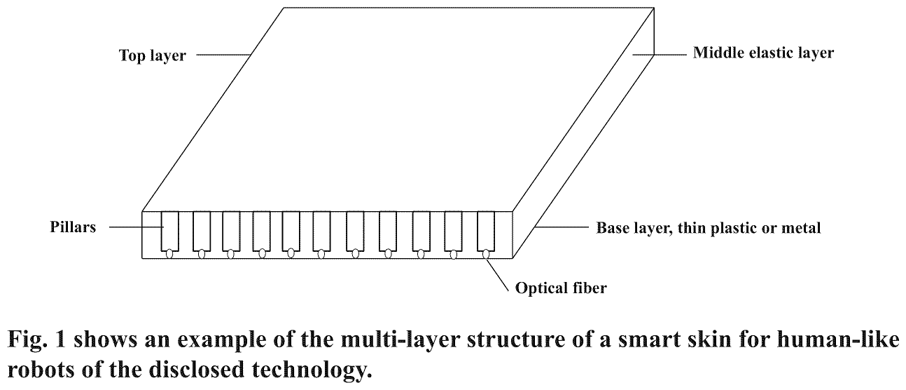

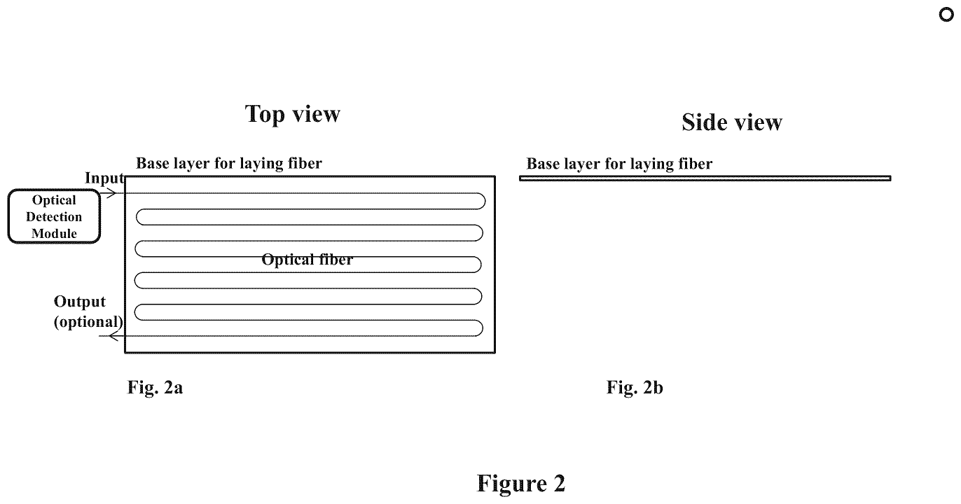

FIG. 1 shows an example of the structure of a multi-layer sensing structure as a smart skin for human-like robots based on the disclosed technology. This particular multi-layer sensing structure or the “skin” includes different layers and is structured to be deformable in response to interactions with its surroundings including a touch and can be stretched or tactile when interacting with external touches. The base layer on the bottom is for laying or supporting an optical fiber, the middle layer above the base layer is an elastic, deformable layer with an array of holes to hold force/pressure sensing elements in form of, e.g., pillars or rods, to allow the force/pressure sensing elements to penetrate through the middle layer for transmitting the sensed force/pressure amounts at different locations to the optical fiber which is coupled to the force/pressure sensing elements. The top layer above the middle layer is a protective layer to cover the elastic middle layer and the sensing pillars down below. This top layer interacts with the outside as a front sensing layer. The force/pressure sensing elements such as force transmitting pillars can be implemented in various configurations, including pillars made with relatively hard materials, such as plastic materials or metals. Each sensing pillar is placed on top of and is engaged to the optical fiber and different sensing pillars are placed at different locations of the optical fiber to be engaged to the optical fiber. The sensing pillars may be arranged as an array over the multi-layer structure and the optical fiber can be placed along a zig-zag pattern or other patterns to pass through the sensing pillars as shown in FIG. 2. Probe light is directed into the optical fiber to pass through locations within the optical fiber where the sensing pillars are engaged.

When a force or pressure is applied to or exerted on the top layer at a particular location, the pillar at that location will be pushed downward to press against the optical fiber below to transmit the force to the optical fiber. This interaction can induce a change in the optical birefringence in the optical fiber at that particular location via the photo-elastic effect in optical fiber. The amount of the locally induced birefringence at that location within the optical fiber is directly proportional to the force or pressure applied to that location of the optical fiber. The probe light in the optical fiber, when passing through that location of the optical fiber, interacts with the optical fiber at that location with the locally induced birefringence to carry information indicative of that induced birefringence due to the local force or pressure. The probe light can be measured to extract the information on the induced birefringence and this measurement can be used to determine the force or pressure applied to that location of the optical fiber. The probe light passes through different locations of the optical fiber carries the information of the induced birefringence at the different locations of the optical fiber and this optical fiber thus can be used as a spatially distributed birefringence sensor system to measure the birefringence distribution over time (e.g., periodically) and convert the birefringence readings into force readings. As will be discussed below, in addition to the induced birefringence, the distributed birefringence sensor system is also capable of measuring the strain and temperature variations along the optical fiber, and therefore can be used to read out the distance resolved birefringence, strain, and temperature values. The skin can be wrapped on the body of a robot to feel the location resolved touching, poking, pressing, stretching, and heat/cold sensations.

Examples for measurements of strain, stress, and temperature by using 1-dimensional and 2-dimensional distributed fiber-optic sensors based on sensing by polarization maintaining optical fiber of distributed polarization crosstalk distribution are disclosed in U.S. Pat. No. 9,476, 699 entitled “Measurements of strain, stress and temperature by using 1-dimensional and 2-dimensional distributed fiber-optic sensors based on sensing by polarization maintaining fiber of distributed polarization crosstalk distribution,” which is incorporated by reference in its entirety as part of the disclosure of this patent document.

The sensing devices in the U.S. Pat. No. 9,476, 699 are capable of measuring stress, strain, or temperature based on polarization crosstalk analysis in birefringence optical birefringent media including polarization maintaining fiber to measure polarization crosstalk distribution in polarization maintaining fiber by placing the PM fiber in a 1-dimensional or 2-dimensional configuration for sensing temperature, stress or strain in the PM fiber at different locations along the fiber with a high spatial sensing resolution, including simultaneous measurements of stress, strain and temperature from analyzing the probe light. For example, the U.S. Pat. No. 9,476, 699 discloses a method for monitoring a temperature of an object by optical sensing that includes coupling a linearly polarized light of a broadband spectrum into an optical birefringent medium as a sensing element which is attached to an object to produce an optical output signal out of the optical birefringent medium; directing the optical output signal to transmit through a linear optical polarizer which is polarized in a direction to cause a mixing between the two orthogonal polarization modes in optical transmission light of the linear optical polarizer; directing the optical transmission light of the linear optical polarizer into an optical interferometer to obtain optical interference of light between the two orthogonal polarization modes in the optical birefringent medium to produce polarization crosstalk peaks; and measuring spacings of polarization crosstalk peaks present in the obtained optical interference to monitor a temperature at different locations of the optical birefringent medium attached to the object. The U.S. Pat. No. 9,476, 699 also discloses an optical fiber sensor device that includes a sensor plate formed of a deformable or clastic material in contact with an object under measurement; a length of polarization maintaining (PM) fiber as a sensing element and engaged to the sensor plate at multiple engaging locations; an optical light source that produces probe light and is coupled to the PM fiber to deliver the probe light into the PM fiber; and a detector module coupled to receive probe light from the PM fiber and to measure the received probe light. The detector module includes an optical interferometer to processing the received probe light to produce an interferometer optical output having polarization crosstalk peaks. The detector module is configured to measure spacings of the polarization crosstalk peaks to determine temperature information of the sensor plate and the object. The U.S. Pat. No. 9,476,699 provides distributed fiber-optic strain sensors using polarization maintaining (PM) fiber as the sensing medium as discrete sensors and distributed sensors in 1D and 2D configurations based on the technology of ghost-peak free distributed polarization crosstalk analyzer (DPXA), commercially available from General Photonics Corporation. The force/pressure sensing elements in the smart skin device in FIG. 1 engaged at different locations of the optical fiber can be combined with the optical sensing using the distributed polarization crosstalk analyzer (DPXA) in U.S. Pat. No. 9,476, 699.

FIG. 2 shows one example of how to deploy an optical fiber in the base layer in FIG. 1. FIG. 2a shows an example of the top view of the base layer on which the optical fiber is laid in a zig-zag pattern to be coupled to the sensing pillars or rods. For example, micro trenches with a depth less than the optical fiber radius can be pre-made on the base layer for guiding the optical fiber along the zig-zag path. The bottom of the trench should be plat for the maximum birefringence induction sensitivity for a giver transverse force. The optical fiber can be laid automatically with an optical fiber routing machine. In some implementations, an adhesive material may be used to glue the optical fiber on the base plate with or without trench. FIG. 2b shows the side view of the base layer, which may have a thickness between 0.1 to 1 mm in some implementations.

In this example of a distributed optical fiber sensor in FIGS. 1 and 2, the spacing between the fiber segments in the optical fiber along the vertical direction defines the vertical resolution of the two dimensional sensing and the spacing between two adjacent force-transmitting pillars or rods in each horizonal optical fiber segment defines the horizontal resolution.

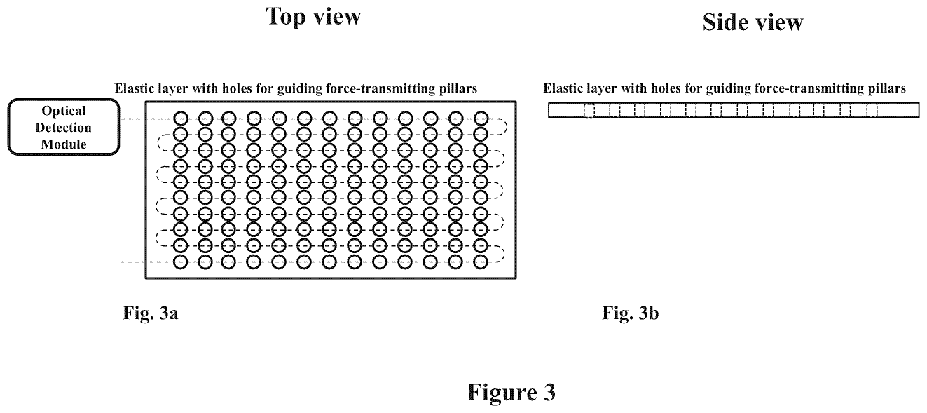

FIG. 3 shows one example of placing force/pressure sensing elements in the middle layer of the smart skin device in FIG. 1. FIG. 3a shows the top view of the middle elastic layer with an array of holes for guiding the force transmitting pillars to go through. In this example, this middle layer is directly put on top of the base layer and each line of the holes for holding the pillars is directly on top of the optical fiber, with the optical fiber running cross the center of the holes to be in contact with different pillars. In some implementations, an adhesive can be used to glue the middle layer to the base layer. FIG. 3b shows the side view of the middle elastic layer, which may have a thickness between 0.2 to 1 mm in some implementations.

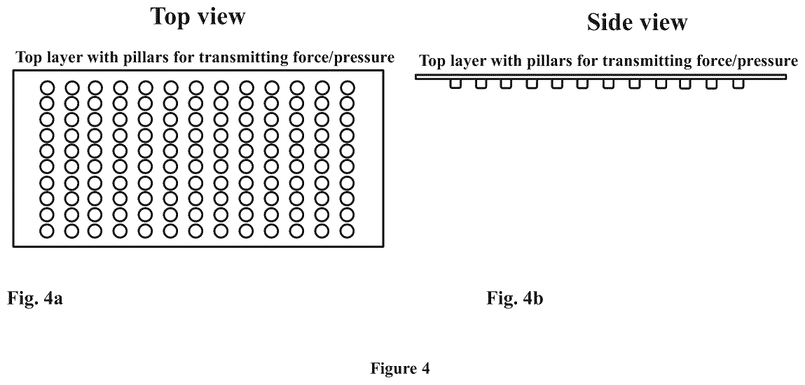

FIG. 4 shows one example of the top layer in the smart skin device in FIG. 1. FIG. 4a shows the top view of the top layer with an array of pillars for transmitting the force/pressure to the optical fiber laid on the base layer through the holes in the middle layer. In some implementations, the pillars can be directly molded on the top sheet or can be made separately with or without attaching to the top sheet. FIG. 4b shows the side view of the top layer with the force-transmitting pillars. The thickness of the top sheet may be between 0.1 to 1 mm and the height of the thickness is between 0.2 mm to 1 mm in some implementations.

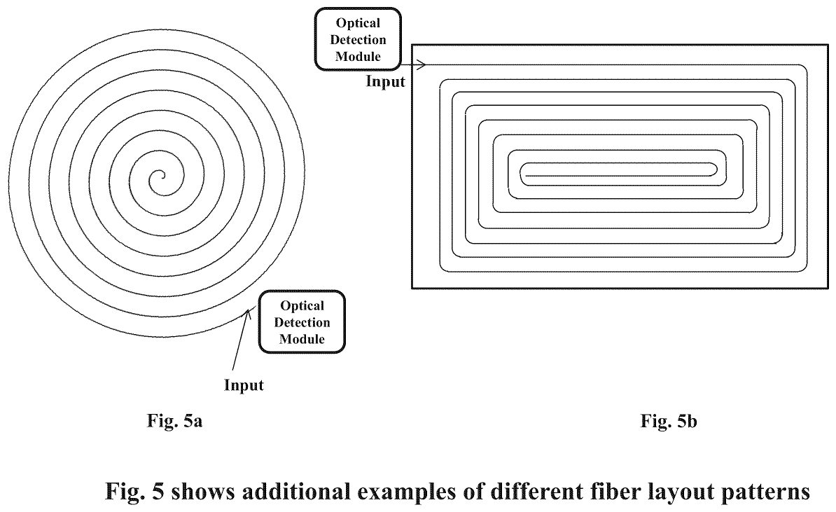

The optical fiber can be deployed in the base layer in various other configurations other than the zig-zag pattern in FIG. 2. FIG. 5 shows examples of different optical fiber layout patterns of the optical fiber where FIG. 5a shows a circular spiral optical fiber routing pattern and FIG. 5b shows a rectangular spiral pattern of the optical fiber.

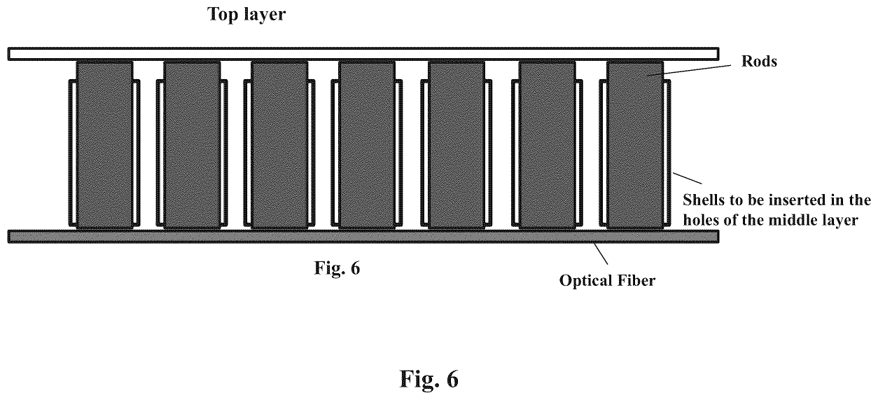

FIG. 6 shows an example of another design of a force transmitting pillar for the middle layer shown in the smart skin device in FIG. 1. This particular design can be used to minimize the friction between the pillars and the holes in the middle elastic layer by implementing a piston like structure to include a pillar shell with a hollow interior and a rod or pillar enclosed in the shell. The pillar shells are inserted in the holes of the middle layer and the rods or pillars are inserted in their corresponding shells. In some implementations, both the shell and the rod can be made with or coated with a self-lubricating material, such as molybdenum disulfide (MoS2), graphite, polytetrafluocthylene (PTFE), linear polyethylenes (PE), and hexagonal boron nitride (h-BN), or a metal or alloy (e.g., brass), for minimizing the friction and the most repeatable force transmission.

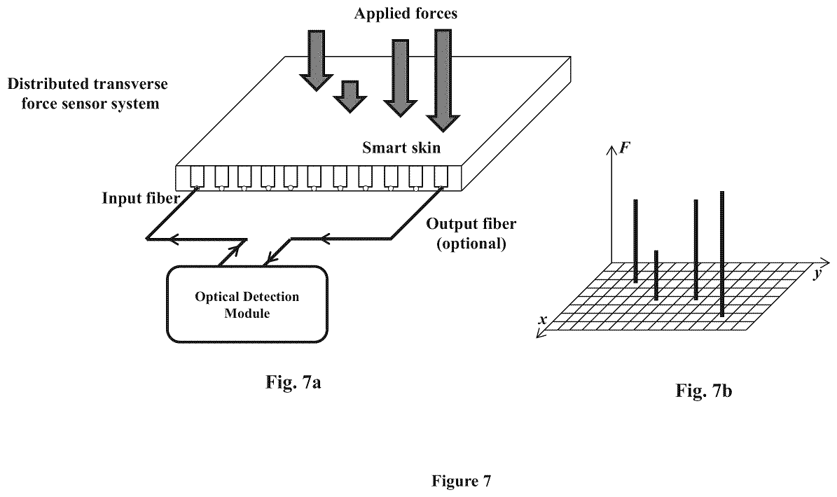

FIG. 7a shows how the multi-layer smart skin works. In this example, an optical detection module is coupled to the input optical fiber where the probe light in directed into the input optical fiber to the different force/pressure sensing elements in the smart skin as part of a distributed transverse sensing system and the output optical fiber that sends the probe light to the optical detection module for measurements. This use of an input optical fiber and an output optical fiber is a transmissive fiber sensing system where the input fiber terminal is the input optical fiber and the output terminal of the same optical fiber is the output optical fiber. For example, such a transmissive fiber sensing system may include first and second optical ports where the first optical port is coupled to the first terminal of the optical fiber to send probe light into the system and the second optical port is coupled to the second terminal of the optical fiber to receive the returned light from the fiber for optical sensing, such as a distributed polarization crosstalk analyzer (DPXA).

In other implementations, the output optical fiber may not be needed when the optical sensor system is designed as a single-ended device that sends probe light into one terminal of the fiber and collects returned light from the same terminal of the fiber for optical sensing, such as a polarization-analyzing frequency domain reflectometery (PA-OFDR) based device disclosed in this patent document.

In either of the system designs, the system can be implemented with processing software where a lookup table can be created to link the fiber location corresponding to a force transmitting rod or pillar, and then to the location on the XY plane of the skin, and thus a mapping between the positions of the forces applied onto the skin, with their magnitudes of the forces at the different locations can be displayed on a computer screen, as shown in FIG. 7b. If using the PA-OFDA as an interrogator, then standard telecommunication single mode optical fiber with core/cladding/buffer diameters of 9, 125, and 250 μm can be used. Optical fiber with smaller diameter can also be used to increase the sensing sensitivity. For example, single mode optical fiber with core/cladding/buffer diameters of 4, 60, and 100 μm or 6, 80, 135 μm can be used. In addition, high Rayleigh scattering fibers created by treating a regular optical fiber with UV radiation or using femotosecond laser to create scattering centers inside can also be used to enhance the measurement sensitivity and repeatability. If a DPXA system is used as the interrogator, the polarization maintaining (PM) optical fiber can be used. The birefringence axis of the PM fiber is aligned 45° from the surface normal of the skin for maximum sensitivity. Other distributed force/pressure sensing interrogation systems may also be used with the disclosed skin structure.

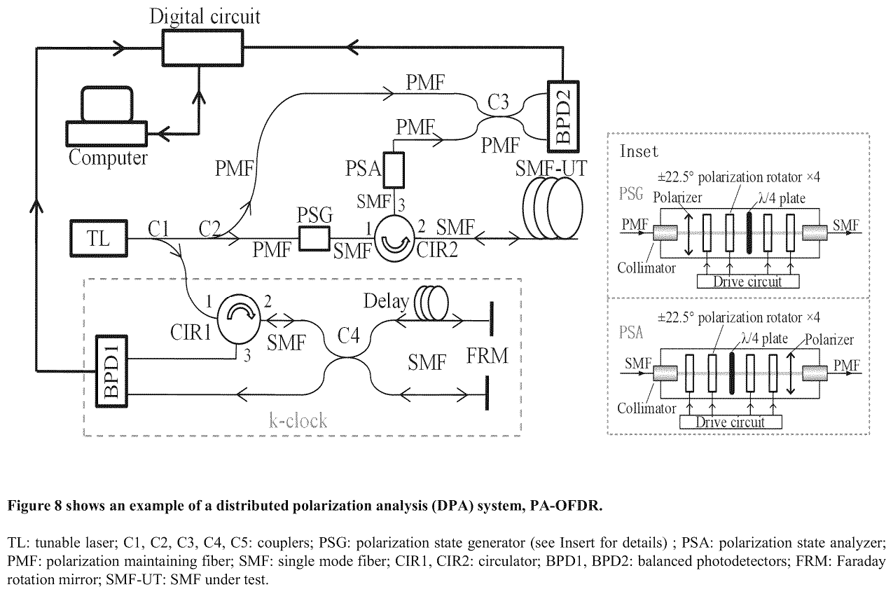

FIG. 8 shows a specific example of the basic schematic of a PA-OFDR as a single-ended device that sends probe light into one terminal of the fiber and collects returned light from the same terminal of the fiber for optical sensing [1, 2]. In this example, the SMF-UT is a single-mode PM fiber that is coupled to the distributed force sensing elements in the robotic skin shown in FIG. 1. Light from a tunable laser (TL) with a long coherence length is coupled into the PM fiber. Around 5% is coupled out by a first coupler C1 to a k-clock consisting of a first circulator (CIR1) and an optical interferometer (e.g., a Michelson interferometer as shown) made with SMF in which two Faraday rotation mirrors (FRMs) are used to eliminate polarization fluctuations. The outputs from the optical interferometer are detected and amplified by a first balanced photodetector (BPD1) to get the incremental frequency of the TL. The light in the PMF continues to propagate and a fraction of this light (e.g., around 10%) is coupled out by a second coupler C2 as a local oscillator (LO) beam. The remaining light first goes through a polarization state generator (PSG) and is then directed into the SMF-UT via a second circulator (CIR2). The back scattered and reflected light from the SMF-UT is directed to port 3 of CIR2 and then goes through a polarization state analyzer (PSA) before entering a PM fiber to be mixed at a third coupler C3 with the LO beam from C2. The interference signals from two outputs of C3 are detected and amplified by a second balanced detector (BPD2), and the output of BPD2 is finally sent to the analog to digital converter (ADC) in the digital circuit board to be converted to digital signal with a desired resolution (e.g., 16 bit resolution). The zero crossings of the interference signal from the k-clock interferometer detected by BPD1 are converted to trigger pulses in the digital circuit to trigger the ADC so that the signal from BPD2 is digitized with equal frequency spacing. The working principle of the k-clock and the data processing algorithm can be found in detail in [3, 4]. Fast Fourier transform (FFT) of the digitized signal then reveals the location information of backscattered and reflected light originated at different locations in the SMF-UT. As in [5-7], both PSG and PSA are made with binary magneto-optical (MO) crystals, as shown in the inset of FIG. 8. The PSG is capable of generating 4 distinctive SOPs. For example, the PSG may include four controllable polarization rotators 1, 2, 3, and 4 that are sequentially placed in the optical path. A quarter waveplate is placed between the rotators 2 and 3 to separate the 4 rotators into two pairs: rotators 1 and 2 as one pair and rotators 3 and 4 as another pair. In addition, an optional input polarizer may be placed in front of the first rotator 1 for aligning the input polarization with respect to the optical axis (c-axis) of the λ/4 plate. The input polarizer may be oriented in various directions, e.g., aligned with the c-axis, or 45° from the c-axis, or other predetermined angle. Each of the polarization rotators may be individually controlled by a control signal as illustrated. Polarization rotations of the rotators are controlled to produce the desired SOPs at the output. In addition, this PSG may also be used as a SOP analyzer or polarimeter to determine the SOP of the received light as is shown in the insert for PSA which is capable of analyzing any SOP with 4 distinctive logic states or MO settings.

The PSG and PSA devices can be implemented in various configurations, including designs invented by Dr. Xiaotian Steve Yao in U.S. Pat. No. 7,027,198B2 for Generation and analysis of state of polarization using tunable optical polarization rotators; U.S. Pat. No. 7,265,836B1 for In-line optical polarimeter using free-space polarization sampling elements; U.S. Pat. No. 7,436,569B2 for Polarization measurement and self-calibration based on multiple tunable optical polarization rotators; and U.S. Pat. No. 7,466,471B2 for Optical instrument and measurements using multiple tunable optical polarization rotators, all of which are incorporated by reference as part of the disclosure of this patent document.

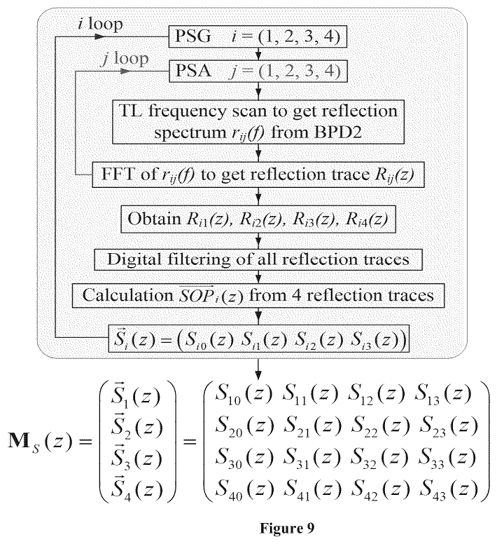

FIG. 9 shows an example of the data acquisition and processing flow chart for measuring the SOP matrix as a function of z. For each frequency scan of the TL, the PSG generates one of four SOPs and the PSA measures the SOP with four sequential MO settings, and a total of 16 frequency scans and PSG/PSA settings are required to get the full Stokes (or SOP) matrix Mₛ(z) of the signal returned from each point along the single mode optical fiber under test (SMF-UT) [1,]:

$${M}_{s} ( z ) = [ \begin{matrix}{S}_{1} ( z ) \\ {S}_{2} ( z ) \\ {S}_{3} ( z ) \\ {S}_{4} ( z )\end{matrix} ] = [ \begin{matrix}{S}_{10} ( z ) & {S}_{11} ( z ) & {S}_{12} ( z ) & {S}_{13} ( z ) \\ {S}_{20} ( z ) & {S}_{21} ( z ) & {S}_{22} ( z ) & {S}_{23} ( z ) \\ {S}_{30} ( z ) & {S}_{31} ( z ) & {S}_{32} ( z ) & {S}_{33} ( z ) \\ {S}_{40} ( z ) & {S}_{41} ( z ) & {S}_{42} ( z ) & {S}_{43} ( z )\end{matrix} ] \qquad ( 1 )$$

where Sᵢ(z)=[Sᵢ₀(z), Sᵢ₁(z), Sᵢ₂(z), Sᵢ₃(z)]^{T}, (i=1, 2, 3, 4), is the Stokes vector of the reflected or back scattered light at location z measured with the PSA corresponding to the ith SOP generated by the PSG. When a polarized light is propagating in the SMF-UT, the evolution of the light's SOP can be described using the well-known equation of motion of the Stokes vector Sᵢ(z) as

$$\frac{\partial S ( z )}{\partial z} = {W}_{rt} ( z ) \times S ( z ) , \qquad ( 2 )$$

where z is the distance of light propagated within the optical fiber, Wᵣₜ(z) is the local round-trip birefringence vector. In practice, one may use the following steps to calculate the birefringence [1]:

For a small optical fiber segment with a length of Δz, the SOP matrix Mₛ(z+Δz) at z+Δz relates to the SOP matrix at z by Mₛ(z+Δz)=M_{Δ}(z)Mₛ(z), where M_{Δ}(z) is the Muller matrix of the optical fiber segment Δz and can be obtained as

$${M}_{Δ} ( z ) = {M}_{s} ( z + Δ z ) {M}_{s}^{- 1} ( z ) \qquad ( 3 )$$

It can be shown that the retardation angle θ(z) can be expressed as [1]:

$$θ ( z ) = {cos}^{- 1} ( \frac{T r [ {M}_{Δ} ( z ) ] - 1}{2} ) = \frac{2 \cdot 2 πΔ n ( z ) Δ z}{λ} \qquad ( 4 )$$

where the factor of 2 accounts for the round trip passage of light in the optical fiber segment. Finally, the local birefringence Δn(z) can be calculated from the θ(z) as

$$Δ n ( z ) = \frac{θ ( z ) λ}{4 π Δ z} \qquad ( 5 )$$

where λ is the wavelength. With the local birefringence obtained, the local transverse or lateral stress can be determined because it is linearly proportional to the birefringence via the photoelastic effect.

When a length of SMF is subject to a transverse line force (TLF) ƒ, the birefringence Δn induced via the photo-elastic effect can be expressed as [8-10]:

$$Δ n = \frac{4 {n}^{3}}{π E} ( 1 + σ ) ( {p}_{12} - {p}_{11} ) ( \frac{f}{d} ) = ζ f \qquad ( 6 a )$$

where the proportion constant ζ relating the TLF and birefringence is defined as the TF measurement sensitivity:

$$ζ = \frac{4 {n}^{3}}{π d E} ( 1 + σ ) ( {p}_{12} - {p}_{11} ) \qquad ( 6 b )$$

Taking the parameters of fused silica: n≈1.46 at 1550 nm, E=6.5×10¹⁰ N/m, p₁₁=0.12, p₁₂=0.27 and σ=0.17, for a SMF with a cladding diameter d=125 μm, the proportion constant ζ is estimated to be 8.559×10⁻⁸ RIU/(N/m). Such a value is calculated by assuming the SMF made with fused silica with uniform stresses inside the core region, without considering the difference between the optical fiber core and cladding.

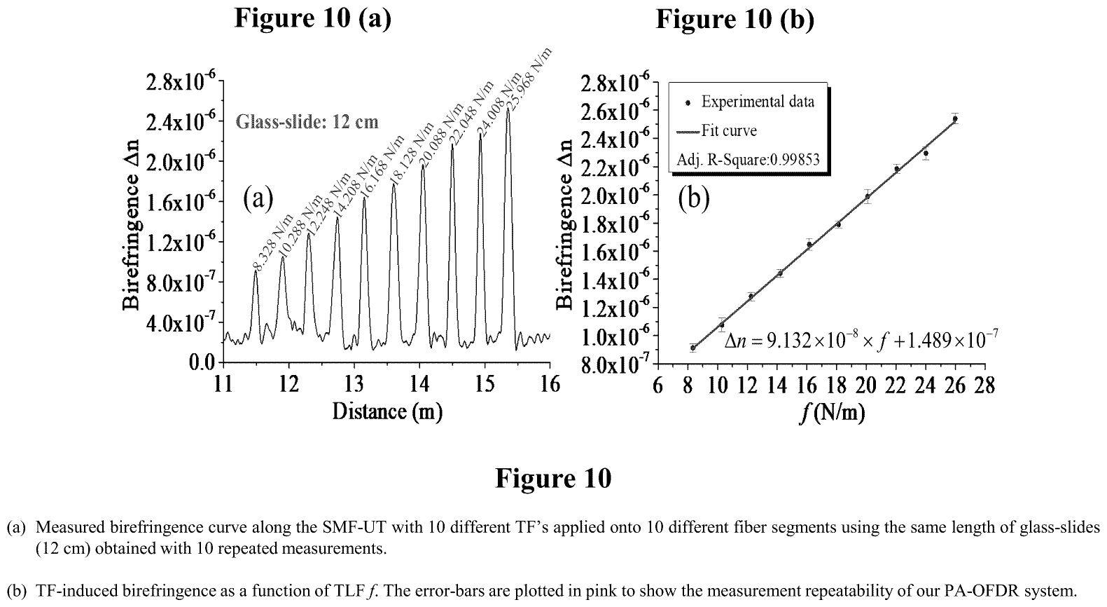

FIG. 10a shows an example of the measured birefringence curve along the SMF-UT with 10 different TF's applied onto 10 different optical fiber segments using the same length of glass-slides (12 cm) obtained with 10 repeated measurements. FIG. 10b shows the TF-induced birefringence as a function of TLF ζ. The error-bars are plotted in pink to show the measurement repeatability of our PA-OFDR system [2].

A fiber sensor system based the disclosed technology can be configured in some implementations to have a maximum and a minimum detectable TLFs of 1.68×10⁴ N/mm and 0.634 N/m, respectively, corresponding to a dynamic range of 44 dB. [2]. The force sensing spatial resolution is 3.7 mm, with a sensing range of 103 m, which can be extended to few km using a laser with longer coherent length. The sensitivity, dynamic range, measurement range and the spatial resolution are sufficient for making a large area of smart skin to cover a human-like robot.

Note that not only a PA-OFDA is capable of measuring transverse force/pressure described above, but also strain and temperature. Therefore, the smart skin has the capabilities of simultaneously feeling the touching, poking, pressing, stretching and heat/cold on the skin, which are important functions of real animal skins.

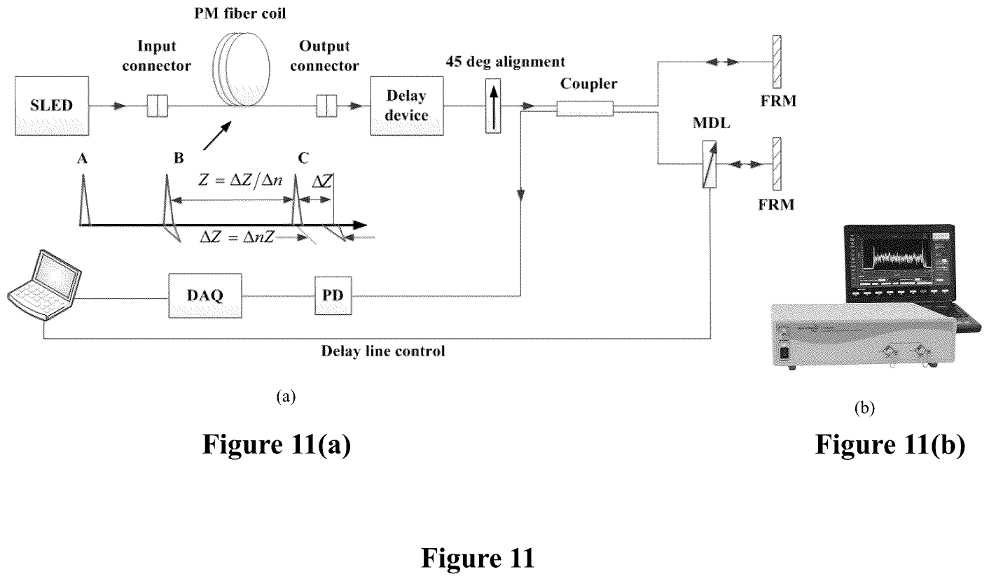

FIG. 11 illustrates a basic configuration for a distributed polarization crosstalk analyzer (DPXA) [11-14]. The “PM fiber coil” in FIG. 11 is the distributed sensing PM fiber which corresponds to the fiber shown in FIG. 1. Examples of optical fiber sensing devices for measuring distributed polarization crosstalk in polarization maintaining optical fiber and optical birefringence material are included in U.S. Pat. No. 8,599,385 for Measuring distributed polarization crosstalk in polarization maintaining fiber and optical birefringent material, which is incorporated by reference as part of the disclosure of this patent document. A broadband light source, such as a polarized super luminescent diode source (SLED) with a very short coherence length (˜25 μm, corresponding to a 3-dB Gaussian line width of 30 nm) is coupled into the slow axis of a PM optical fiber under test (FUT) (point A of inset in FIG. 11). Assume at point B, a polarization crosstalk is induced by an external disturbance and then some lights are coupled into the fast axis of the PM optical fiber with a coupling coefficient parameter h=/I₁/I₂, where I₁ and I₂ are the light intensities in the fast and slow axes of the PM optical fiber, respectively. Because the polarized lights along the fast axis travel faster than that along the slow axis, at output of the optical fiber the faster light component will be ahead of the slow component by ΔZ=ΔnZ, where ΔZ is an optical path length difference, Δn is a group birefringence of the PM optical fiber and Z is the optical fiber length between the point where the crosstalk occurs (B) and the output end (point C). A polarizer oriented at 45° to the slow axis of the PM FUT was placed at the end of the optical fiber. Polarization components from both slow and fast axes were projected onto a same direction of the linear polarizer axis so as to produce interference pattern between those two components in a scanning Michelson interferometer. When the relative optical path length is scanned, an interference peak appears whenever these two polarization components are overlapped in the space but disappears when they are separated more than a coherence length of light source (i.e. SLED). Then the group birefringence Δn of PM FUT between two positions B and C can be calculated as following:

$$Δ n = Δ Z / Z \qquad ( 7 )$$

It is evident from Eq. (7) that the accuracy of Δn depends on the measurement accuracies of both ΔZ and Z.

In general, the transverse force induced coupling ratio or polarization crosstalk h, which is defined as the ratio between the coupled power in the fast axis and the original power in the slow axis, can be expressed as [15, 16]:

$$h = {F}^{2} {sin}^{2} 2 α \cdot {\{ \frac{sin [ π \sqrt{1 + {F}^{2} + 2 F cos 2 α} ( l / {L}_{b 0} ) ]}{\sqrt{1 + {F}^{2} + 2 F cos 2 α}} \}}^{2} \qquad ( 8 )$$

where α is the angle between the applied force ƒ and the fast axis of the PM optical fiber (the force angle), L_{b0} is the beat length of PM optical fiber of the unstressed section, and F is the normalized force given by

$$F = \frac{2 {n}^{3} {L}_{b 0} f ( 1 + μ ) ( {P}_{12} - {P}_{11} )}{π λ r E} \qquad ( 9 )$$

In Eq. (9), r is the radius of the PM optical fiber, n is the refractive index of the fast axis, ƒ is the magnitude of the force applied to the optical fiber per unit length (ƒ=Fₑₓ/l), μ is the Poisson coefficient, p₁₂ and p₁₁ are the optical strain coefficients, λ is the wavelength of the light source, and E is the Young's modulus of the optical fiber. Using the parameters for fused silica, Eq. (9) can be simplified to:

$$F = \frac{5.46 {L}_{b 0}}{r λ} f \qquad ( 10 )$$

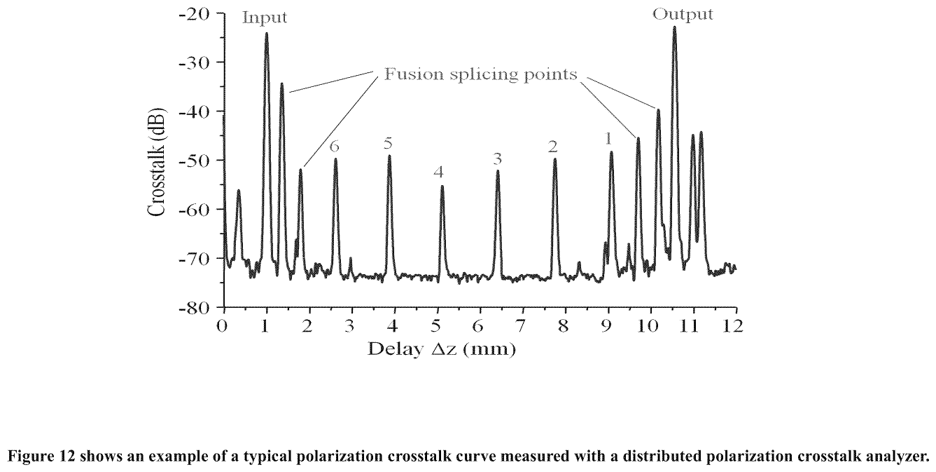

FIG. 12 shows a typical polarization crosstalk curve as a function of delay (from the MDL in FIG. 11) measured with a DPXA. The peaks marked Input and Output are due to the birefringence axis misalignments at the input and output connectors. There are also four crosstalk peaks from the axis misalignment at four fusion splice points. The peaks labeled 1-6 are the transverse force induced crosstalks by placing different weights on the optical fiber at different locations along the PM optical fiber. Clearly, the magnitude and location of a transverse force can be uniquely measured and identified.

The disclosed sensing system with DPXA is capable of measuring the transverse a long a PM optical fiber for with a length range up to 4 km and a spatial resolution of 6 cm. The length range is sufficient to make a skin sufficiently large to cover the body of a human-like robot, but the spatial resolution is not. Further improvement is required. In addition, the DPXA is also capable to sense the temperature along the optical fiber [17, 18] and therefore enables the smart skin to simultaneously sense the temperature variations at different locations on the skin. Again, the temperature sensing spatial resolution also needs to be improved.

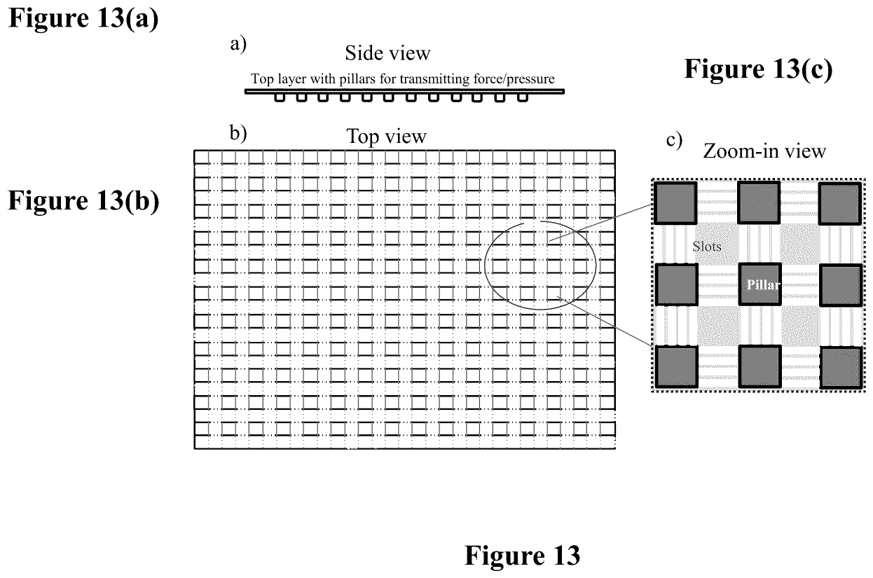

FIG. 13 shows another example of a smart skin device. FIG. 13a shows the side view of the top layer of an embodiment which has arrays of square shaped pillars for transmitting the force/pressure to the fiber laid on the base layer. The square shaped pillars can be molded together with the top sheet, or milled with a milling machine on a sheet of metal or plastic material, or even printed using a 3D printer. FIG. 13b shows the top view of the top layer with the square shaped force-transmitting pillars. In this example, the middle elastic layer described in the smart skin device in FIG. 1 is eliminated in this particular design since the pillars are already fixed in position on the top layer. FIG. 13c shows the zoom-in view of the top layer, in which narrow slots can be seen cut around the square pillars to make each pillar more flexible for the slight up and down motion in operation. The thickness of the top sheet may be between 0.1 to 1 mm and the height of the pillars is between 0.2 mm to 0.99 mm in some implementations.

In various implementations of smart skin devices based on the disclosed technology, an optical detection module is included and is coupled to the first terminal of the optical fiber to launch light into the optical fiber and receive backscattered light from the optical fiber for measuring the light that carries information of the localized birefringence in the fiber induced by transmitted forces by the different force sensing elements. In other implementations, the optical detection module may include an optical frequency domain reflectometer (OFDR) with polarization analysis capability for obtaining distance resolved birefringence along the optical fiber with high spatial resolution, or the optical a time domain reflectometer (OTDR) with polarization analysis capability for obtaining distance resolved birefringence along the optical fiber with high spatial resolution. In yet other implementations, the optical detection module can be designed to include a pulsed light source to generate light pulses to the optical fiber so that the returned light pulses from the optical fiber can be detected and processed to measure a spatial distribution of the force or temperature in the optical fiber based on Brillouin time domain reflectometry (BOTDR) measurements. [20, 21].

This patent document includes the disclosure of the following listed documents for various features of the disclosed technology as attachments:
1. T. Feng, Y. Shang, X. Wang, S. Wu, A. Khomenko, X. Chen and X. S. Yao, Distributed polarization analysis with binary polarization rotators for the accurate measurement of distance-resolved birefringence along a single-mode fiber. Opt. Express 26 (20): pp. 25989-26002 (2018).
2. T. Feng, J. Zhou, Y. Shang, X. Chen and X. S. Yao, Distributed transverse-force sensing along a single-mode fiber using polarization-analyzing OFDR. Opt. Express 28 (21): pp. 31253-31271 (2020).
3. Z. Ding, T. Liu, Z. Meng, K. Liu, Q. Chen, Y. Du, D. Li and X. S. Yao, Improving spatial resolution of optical frequency-domain reflectometry against frequency tuning nonlinearity using non-uniform fast Fourier transform. Review of Scientific instruments. 83 (6): pp. 066110 (2012).
4. Z. Ding, X. S. Yao, T. Liu, Y. Du, K. Liu, J. Jiang, Z. Meng, and H. Chen, Compensation of laser frequency tuning nonlinearity of a long range OFDR using deskew filter. Opt. Express. 21 (3): pp. 3826-3834 (2013).
5. X. S. Yao, L. Yan and Y. Shi, Highly repeatable all-solid-state polarization-state generator. Opt. Lett. 30 (11): pp. 1324-1327 (2005).
6. X. S. Yao, X. Chen and L. Yan, Self-calibrating binary polarization analyzer. Opt. Lett. 31 (13): pp. 1948-1950 (2006).
7. A. M. Smith, Birefringence induced by bends and twists in single-mode optical fiber. Appl. Opt. 19 (15): pp. 2606-2611 (1980).
8. A. M. Smith, Single-mode fibre pressure sensitivity. Electron. Lett. 16 (20): pp. 773-774 (1980).
9. X. Chen and X. S. Yao, Measuring distributed polarization crosstalk in polarization maintaining fiber and optical birefringence material. U.S. Pat. No. 8,599,385, filed 14 May 2010, issued 3 Dec. 2013.
10. Z. Li, X. S. Yao, X., Chen, H. Chen, Z. Meng, and T. Liu, Complete Characterization of Polarization-Maintaining Fibers Using Distributed Polarization Analysis. J. Lightwave Technol. 33 (2): pp. 372-380 (2015).
11. T. H. Chua and C. L. Chen, Fiber polarimetric stress sensors. Appl. Opt. 28 (15): pp. 3158-3165 (1989).
12. H. Zhang, Y. Wang, G. Wen, D. Jia and T. Liu, Frequency demodulation of dynamic stress based on distributed polarization coupling system. J. Lightw. Technol. 36 (11): pp. 2094-2099 (2018).
13. D. Ding, T. Feng, Z. Zhao, H. Su, Z. Li and X. S. Yao, Demonstration of distributed fiber optic temperature sensing using polarization crosstalk analysis,” in Conference on Lasers and Electro-Optics (Optical Society of America, San Jose, California, 2016), p. JTu5A.105 (2016).
14. X. S. Yao, Measurements of strain, stress, and temperature by using 1-dimensional and 2-dimensional distributed fiber-optic sensors based on sensing by polarization maintaining fiber of distributed polarization crosstalk distribution. U.S. Pat. No. 9,476,699: filed 5 Mar. 2015, issued 25 Oct. 2016.
15. Hao, Peng, et al., PM fiber based sensing tapes with automated 45° birefringence axis alignment for distributed force/pressure sensing, Optics Express, 28 (13), pp. 18829-18842 (2020).
16. U.S. Pat. No. 7,027,198B2, Generation and analysis of state of polarization using tunable optical polarization rotators.
17. U.S. Pat. No. 7,265,836B1, In-line optical polarimeter using free-space polarization sampling elements.
18. U.S. Pat. No. 7,436,569B2, Polarization measurement and self-calibration based on multiple tunable optical polarization rotators.
19. U.S. Pat. No. 7,466,471B2, Optical instrument and measurements using multiple tunable optical polarization rotators. U.S. Pat. No. 7,466,471
20. Qing Bai et al, “Recent Advances in Brillouin Optical Time Domain Reflectometry,” in Sensors 2019, 19, 1862; doi: 10.3390/s19081862
21. Jian Fang et al., “Single-shot distributed Brillouin optical time domain analyzer,” Vol. 25, No. 13 |26 Jun. 2017| OPTICS EXPRESS 15188, https://doi.org/10.1364/OE.25.015188

All the above documents are incorporated by reference as part of the disclosure of this patent document.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Only a few implementations and examples are described and other implementations. enhancements and variations can be made based on what is described and illustrated in this patent document.

What is claimed is what is described and illustrated, including:

1. A multi-layer device capable of sensing, comprising:
a layer that includes force sensing elements spatially distributed relative to one another, each force sensing element structured to transmit a force exerted on a first end of the sensing element on a first side of the layer to a second end of the forcing sensing element on a second side of the layer opposite to the first side; and
an optical fiber located on the second side of the layer and coupled to the force sensing elements at different locations along a length of the optical fiber, wherein the optical fiber includes a first terminal that receives input light and a second terminal, and is coupled to the second end of each force sensing element to receive a force transmitted from the force sensing element to exhibit a localized birefringence in the optical fiber induced by the transmitted force at a location of the optical fiber coupled to the force sensing element to indicate the transmitted force so that different locations of the optical fiber coupled to the different force sensing elements of the layer generate a spatially distributed sensing of forces experienced by the different force sensing elements.

2. The device as in claim 1, comprising:
an optical detection module coupled to the first terminal of the optical fiber to launch light into the optical fiber and receive backscattered light from the optical fiber for measuring the light that carries information of the localized birefringence in the fiber induced by transmitted forces by the different force sensing elements.

3. The device as in claim 2, wherein the optical detection module includes an optical frequency domain reflectometer (OFDR) with polarization analysis capability for obtaining distance resolved birefringence along the optical fiber with high spatial resolution.

4. The device as in claim 2, wherein the optical detection module includes a time domain reflectometer (OTDR) with polarization analysis capability for obtaining distance resolved birefringence along the optical fiber with high spatial resolution.

5. The device as in claim 2, wherein the optical detection module includes a pulsed light source to generate light pulses to the optical fiber and is configured to detect returned light pulses from the optical fiber to measure a spatial distribution of the force or temperature in the optical fiber based on Brillouin time domain reflectometry (BOTDR) measurements.

6. The device as in claim 1, comprising:
an optical detection module that includes a first optical port coupled to the first terminal of the optical fiber to send light into the optical fiber and a second optical port coupled to the second terminal of the fiber to receive light from the optical fiber and to include an optical interferometer to process the received light from the optical fiber to produce an interferometer optical output having polarization crosstalk peaks with their amplitude indicative of the forces exerted on the optical fiber, and the optical detection module is configured to measure both the amplitudes and spacings of the polarization crosstalk peaks to determine temperature distribution along the optical fiber.

7. The device as in claim 6, wherein the optical detection module includes a distributed polarization crosstalk analyzer (DPXA) that processes the received light from the optical fiber to measure distance resolved polarization crosstalk peaks along the optical fiber, with their amplitudes indicative of the force and the spacings indicative of the local temperature.

8. The device as in claim 6, wherein the optical detection module includes a pulsed light source to generate light pulses to the optical fiber and the optical detection module is configured to detect returned light pulses from the optical fiber to measure a spatial distribution of the force or temperature in the optical fiber based on Brillouin time domain reflectometry (BOTDR) measurements.

9. The device as in claim 1, comprising:
an optical detection module coupled to the first terminal of the optical fiber to launch light into the optical fiber and receive light from the optical fiber and to measure the light that carries information of the localized birefringence in the optical fiber induced by transmitted forces by the different force sensing elements, wherein the optical detection module is further configured to process the received light from the optical fiber to measure a spatial temperature and strain distributions along the length of the optical fiber.

10. The device as in claim 1, wherein the layer that includes the force sensing elements is an elastic layer.

11. The device as in claim 1, wherein the layer that includes the force sensing elements is structured to be deformable.

12. The device as in claim 1, further comprising a rear layer coupled to the second side of the layer of the force sensing elements and structured to hold the optical fiber to be coupled to second ends of the force sensing elements.

13. The device as in claim 1, wherein the force sensing element is a rod made with a metal, plastic, or a synthetic material.

14. The device as in claim 1, wherein the force sensing element includes a shell with a hollow interior to provide a through hole and a rod inserted in the through hole of the shell to move freely with a minimum friction.

15. The device as in claim 14, wherein the shell and the rod include a self-lubricating material to reduce a friction when the rod moves within the shell.

16. The device as in claim 15, wherein the self-lubricating material includes molybdenum disulfide (MoS₂), graphite, polytetrafluoethylene (PTFE), linear polyrthylenes (PE), hexagonal boron nitride (h-BN), or a metal or alloy (including brass).

17. The device as in claim 1, wherein the layer that includes force sensing elements includes:
a holding layer configured to have through holes spatially separated from one another, wherein the force sensing elements are disposed in the through holes, respectively.

18. The device as in claim 17, wherein each force sensing element includes:
a shell with a hollow interior to provide a through hole; and
a rod movable inserted in the through hole of the shell.

19. The device as in claim 18, wherein the shell and the rod include a self-lubricating material to reduce a friction when the rod moves within the shell.

20. The device as in claim 19, wherein the self-lubricating material includes molybdenum disulfide (MoS₂), graphite, polytetrafluoethylene (PTFE), linear polyrthylenes (PE), hexagonal boron nitride (h-BN), or a metal or alloy (including brass).

21. A multi-layer device capable of operating as a robotic sensing system, comprising:
a deformable layer that includes a deformable material structured to include through holes spatially separated from one other, and force sensing elements disposed in the through holes, each force sensing element structured to transmit a force exerted on a first end of the sensing element on a first side of the layer to a second end of the forcing sensing element on a second side of the layer opposite to the first side;
an optical fiber located on the second side of the deformable layer and coupled to the force sensing elements at different locations along a length of the optical fiber, wherein the optical fiber includes a first terminal that receives input light and a second terminal, and is coupled to the second end of each force sensing element to receive a force transmitted from the force sensing element to exhibit a localized birefringence in the optical fiber induced by the transmitted force at a location of the optical fiber coupled to the force sensing element to indicate the transmitted force so that different locations of the optical fiber coupled to the different force sensing elements of the layer generate a spatially distributed sensing of forces experienced by the different force sensing elements; and
an optical detection module coupled to the optical fiber to receive light from the optical fiber to measure the received light to obtain information on a spatial force distribution or a spatial temperature distribution on the front sensing layer.

22. The device as in claim 21, wherein the optical detection module includes a first optical port coupled to a first terminal of the optical fiber to send light into the optical fiber and a second optical port coupled to a second terminal of the fiber to receive light from the optical fiber for measuring the received light to obtain information on the spatial force distribution or the spatial temperature distribution on the front sensing layer.

23. The device as in claim 21, wherein the optical detection module includes an optical port coupled to one terminal of the optical fiber to send light into the optical fiber and to receive light from the optical fiber for measuring the received light to obtain information on the spatial force distribution or the spatial temperature distribution on the front sensing layer.
